(19) United States
(12) Patent Application Publication
(10) Pub. No.: US 2007/0079128 A1
(43) Pub. Date: Apr. 5, 2007

(54) ELECTRONIC SIGNATURE SYSTEM AND METHOD

(75) Inventors: Hua-Dong Cheng, Shenzhen (CN); Duo Liu, Shenzhen (CN); Kuan-Hong Hsieh, Shenzhen (CN); Wen-Chuan Lian, Shenzhen (CN); Xiao-Guang Li, Shenzhen (CN)

Correspondence Address: NORTH AMERICA INTELLECTUAL PROPERTY CORPORATION, P.O. BOX 506, MERRIFIELD, VA, 22116, US

(73) Assignee: HON HAI PRECISION INDUSTRY CO., LTD., Taipei Hsien (TW)

(21) Appl. No.: 11/309,375

(22) Filed: Aug. 2, 2006

(30) Foreign Application Priority Data
Aug. 26, 2005 (CN) 200510036897.4

(51) Int. Cl. H04L 9/00

(52) U.S. Cl. 713/176

(57) ABSTRACT

An electronic signature system is provided. The system includes a server and a database for storing a plurality of signature selections. The server includes a signature task setting module for receiving a request for signing a document which has a document type, and setting the signature procedure according to the document type; a transmitting module for simultaneously distributing the document to designated signers; a signature selection setting module for receiving a signature selection selected by each signer in real-time; a signature selection analyzing module for obtaining the signature selections, analyzing the signature selections, thereby generating an analysis result; a determining module for determining whether a current designated signer has a right to sign the document according to the analysis result; and a signature performing module for signing the document if the current designated signer has the right. An electronic signature method is also provided.

### TECHNICAL FIELD

The present invention relates generally to electronic management platforms of an enterprise, and particularly to an electronic signature system and method.

### GENERAL BACKGROUND

Today, a document signature is a necessity in enterprise operation. Conventional document signature methods involve manual handiwork. It not only wastes manpower, but also wastes time. In order to solve the problems, an electronic signature is needed.

With the development of computer technology, many electronic signature methods have been introduced. In the electronic signature methods, a user defines a signature procedure of a document, each signer signs the document according to the defined order. That is, the first signer signs the document, and then transmits the signed document to the second signer; the second signer signs the document and transmits the signed document to the third signer, and so on. Each signer signs the document after the previous designated signer has signed the document signature. However, sometimes a second signer may delay to sign thus causing subsequent signer such as the third signer and the fourth signer can not sign. This is not time efficient, thereby prolonging a signature time.

Accordingly, what is needed is an electronic signature system and method which can overcome the above-described problems and improves signature efficiency.

### SUMMARY

An electronic signature system is provided. The electronic signature system includes a server and a database. The database stores a plurality of signature selections. The server includes: a signature task setting module for receiving a request for signing a document which has a document type, and setting the signature procedure according to the document type; a transmitting module for simultaneously distributing the document to designated signers; a signature selection setting module for receiving a signature selection selected by each signer in real-time; a signature selection analyzing module for obtaining the signature selections, analyzing the signature selections, thereby generating an analysis result; a determining module for determining whether a current designated signer has a right to sign the document according to the analysis result; and a signature performing module for signing the document if the current designated signer has a right to sign the document; wherein the transmitting module transmits an evaluated decision to a next designated signer according to the analysis result.

An electronic signature method is also provided. The method includes the steps of: (a) receiving a request for signing a document which has a document type; (b) setting a signature procedure according to the document type; (c) simultaneously distributing the document to designated signers; (d) receiving a signature selection selected by each designated signer; (e) obtaining the signature selections, and analyzing the signature selections, thereby generating an analysis result; (f) determining whether a current designated signer has a right to sign the document according to the analysis result; (g) signing the document if the current designated signer has a right to sign the document, and (h) transmitting an evaluated decision to the next designated signer according to the analysis result.

A computer enabling electronic signature is further provided. The computer includes: a signature task setting module for receiving a request for signing a document which has a document type, and setting the signature procedure according to the document type; a transmitting module for simultaneously distributing the document to designated signers; a signature selection setting module for receiving a signature selection selected by each signer in real-time; a signature selection analyzing module for obtaining the signature selections, analyzing the signature selections, thereby generating an analysis result; a determining module for determining whether a current designated signer has a right to sign the document according to the analysis result; and a signature performing module for signing the document if the current designated signer has a right to sign the document; wherein the transmitting module transmits an evaluated decision to a next designated signer according to the analysis result.

Other advantages and novel features will be drawn from the following detailed description with reference to the attached drawings, in which:

### BRIEF DESCRIPTION OF DRAWINGS

FIG. 1 is an application circumstance diagram of an electronic signature system in accordance with a preferred embodiment of the present invention;

FIG. 2 is a block diagram of a hardware infrastructure of the electronic signature system of FIG. 1;

FIG. 3 is a flowchart of a preferred electronic signature method by implementing the system of FIG. 1; and

FIG. 4 is a flowchart of implementing a step of the method of FIG. 3, namely flexibly signing the document.

### DETAILED DESCRIPTION OF THE PREFERRED EMBODIMENT

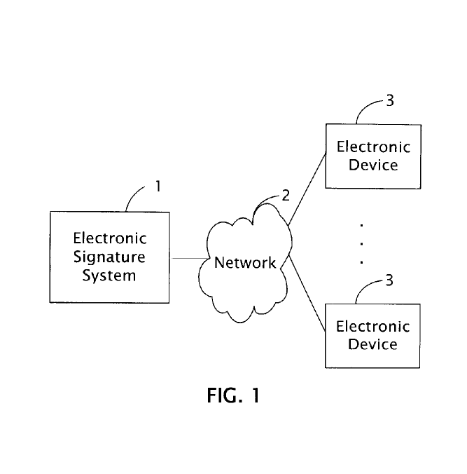

FIG. 1 is an application circumstance diagram of an electronic signature system in accordance with a preferred embodiment of the present invention. The electronic signature system 1 is connected with a plurality of electronic devices 3 through a network 2. The network 2 may be any suitable communication architecture required by the system, such as a wired network or a wireless network. In this preferred embodiment, the former is adopted as an example. The wired network may be an intranet or the Internet. The electronic device 3 may be a Personal Computer (PC), a notebook, an electronic book, a mobile telephone, a Personal Digital Assistant (PDA), and so on. The electronic signature system 1 allows a user to apply for a document signature, allows designated signers to perform document signature tasks via the electronic device 3, and transmits the document to preset recipients whom are either all designated document signers or document informers or both when all designated signers have signed the document. In the preferred embodiment, the signers need to sign the document; the informers are persons who need to know the document, or further perform regulations in the document after the document has been signed by all signers, they are persons except for the signers; the recipients are either all designated document signers or document informers or both.

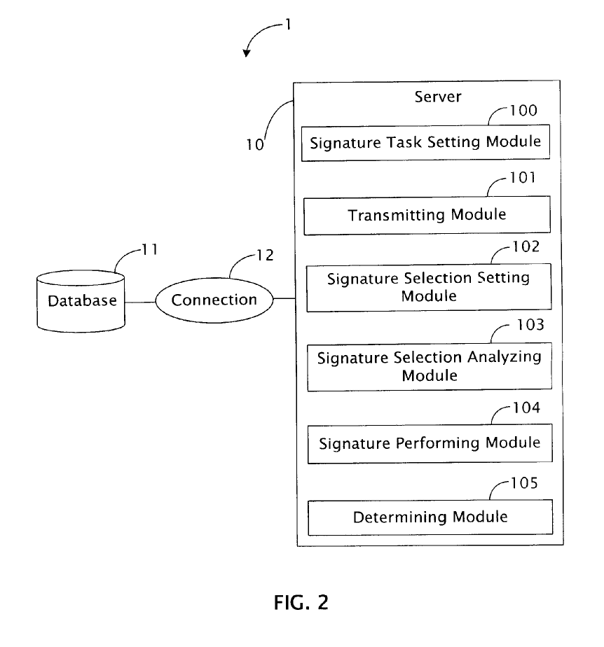

FIG. 2 is a block diagram of a hardware infrastructure of the electronic signature system 1 of FIG. 1. In the preferred embodiment, the electronic signature system 1 mainly includes a server 10 and a database 11. The server 10 is connected to the database 11 via a connection 12. The connection 12 is a database connectivity such as an Open Database Connectivity (ODBC) or a lava Database Connectivity (JDBC).

The database 11 stores a principle for applying for a document signature, a principle for setting a signature procedure, and a plurality of signature selections. In the preferred embodiment, the electronic signature system 1 includes two signature order options: a non-ordered option and a hierarchal ordered option. Each signature order option corresponds to certain document types. For example, when the document is a project document, the signature order option is preferably the non-ordered option; when the document is a charge paying document or an administrational document, the signature order option is preferably the hierarchal ordered option.

The non-ordered option means that all designated signers must sign the document regardless of a signature order of the document. The hierarchal ordered option means that all designated signers must sign the document in a hierarchal order. In regards to the hierarchal order, the hierarchal ordered option is further configured with a plurality of signature selections, such as, a signer delegation selection, a pass on selection, a direct comment selection, a direct signature selection, a signer supplement selection, a signer cancellation selection, and so on.

The signer delegation selection means that the designated signer delegates another document signer to sign the document on the designated signer's behalf.

The pass on selection opinion means that the signer directly transmits the document to the following higher hierarchal signer without any comment or signatures.

The direct comment selection means that the document signer directly comments on the document and signs the document without waiting for evaluated decisions from the preceding lower hierarchal signers. Furthermore, if the document signer has performed the direct comment selection in the case that the preceding lower hierarchal signers have not signed the document, the preceding lower hierarchal signers' evaluated decisions are negligible i.e., the signature of the preceding lower hierarchal signers are not required.

The direct signature selection means that the signer directly signs the document without waiting for the evaluated decisions from the preceding lower hierarchal signers. Furthermore, if the signer with the direct signature selection has performed the signature in the case that the preceding lower hierarchal signers have not signed the document, the preceding lower hierarchal signers thereupon does not need to sign the document any more.

The signer supplement selection means that the signer adds an immediately preceding lower hierarchal signer. Consequently, the signer with the signer supplement selection has to sign the document after the adder signer signs the document.

The signer cancellation selection means that the signer cancels one or more signers in the preceding lower hierarchal signatures.

If the signer does not select any signature selections, the signer waits for evaluated decisions from one or more signers in the preceding lower hierarchal signatures.

The server 10 includes a signature task setting module 100, a transmitting module 101, a signature option setting module 102, a signature option analyzing module 103, a signature performing module 104, and a determining module 105.

The signature task setting module 100 receives a request for signing the document, and obtains document informers input after the signature procedure is finished. The determining module 105 determines the signature order option according to a document type. The signature task setting module 100 further sets a signature procedure and corresponding signers according to the signature order option. However, in other cases, the signers can be manually inputted.

If the signature order option is the non-ordered option, the transmitting module 101 simultaneously distributes the document to the all designated signers. Each signer directly signs the document without waiting for evaluated decisions from other signers.

If the signature order option is the hierarchal ordered option, the transmitting module 101 also simultaneously distributes the document to all designated signers. The document further provides information indicating a signature hierarchal that each signer belongs to and signature selections that each signer can select corresponding to the signature hierarchal.

The signature selection setting module 102 receives a signature selection selected by each designated signer in real-time. The signature selection analyzing module 103 obtains all signature selections, analyzes the signature selections, thereby generating an analysis result. The analysis result includes: document signed, and document not signed. Specifically, if any signer, which is in a higher signature hierarchal ordered than the current signer, does not choose the selection on direct comment selection, direct signature selection, or signer cancellation selection (i.e., the cancelled signer is the current signer) before the current signer signs the document, the signature selection analyzing module 103 thereupon generates the analysis result “document signed”, that means the current signer has a right to sign the document, the evaluated decision from all signers who have signed the document will be transmitted the current signer; otherwise, the signature selection analyzing module 103 generates the analysis result “document not signed”, that means the current signer does not have a right to sign the document.

The determining module 105 determines whether a current designated signer has a right to sign the document according to the analysis result. If so, the signature performing module 104 signs the document. The determining module 105 further determines whether the current designated signer is the last one. If the current designated signer is the last one, the transmitting module 101 distributes the signed document to the designated recipients whom are either all designated document signers or document informers or both. Otherwise, the transmitting module 101 transmits the evaluated decision to the next signer according to the analysis result.

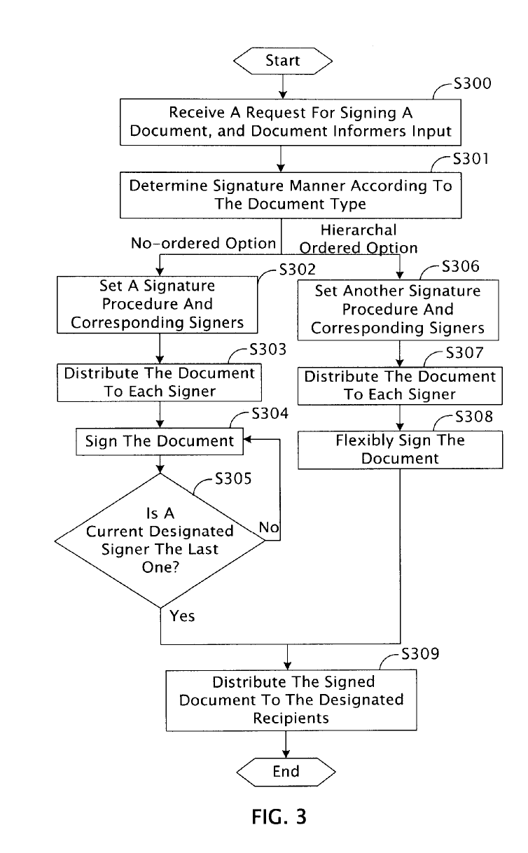

FIG. 3 is a flowchart of a preferred method of an electronic signature method for implementing the system of FIG. 1. In step S300, the signature task setting module 100 receives a request for signing a document, and obtains document informers input after the signature procedure is finished. In step S301, the determining module 105 determines a signature order option according to the document type. If the signature order option is the non-ordered option, in step S302, the signature task setting module 100 sets a signature procedure and corresponding signers. In step S303, the transmitting module 101 simultaneously distributes the document to the designated signers. In step S304, the signer signs the document via the signature performing module 104. In step S305, the determining module 105 determines whether the current designated signer is the last one. If the current designated signer is the last one, in step S309, the transmitting module 101 distributes the signed document to the designated recipients, and the procedure is finished. Whereas, the procedure returns to step S304 described above, another signer signs the document via the signature performing module 104.

If the signature order option is a hierarchal ordered option, in step S306, the signature task setting module 100 sets another signature procedure and corresponding signers. In step S307, the transmitting module 101 simultaneously distributes the document to the designated signers. In step S308, the signers flexibly signs the document, whereupon the procedure goes to step S309 described above.

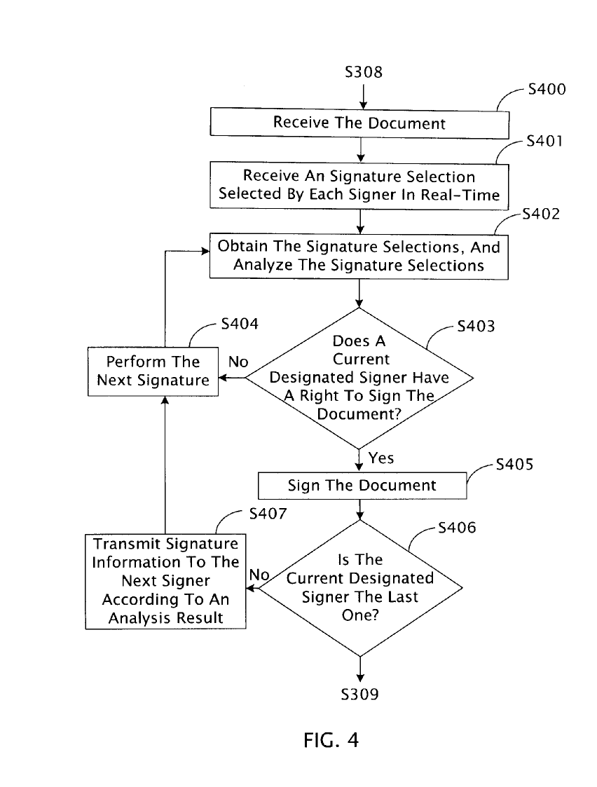

FIG. 4 is a flowchart of implementing step S308 of the method of FIG. 3, namely flexibly signing the document. In step S400, the designated signers receive the document via the electronic device 3. In step S401, the signature selection setting module 102 receives a signature selection selected by each designated signer in real-time. In step S402, the signature selection analyzing module 103 obtains the signature selections and respectively analyzes each signature selection, thereby generates a analysis result. The analysis result includes: document signed, document not signed. In step S403, the determining module 105 determines whether a current designated signer has a right to sign the document according to the analysis result. If the current designated signer does not have a right to sign, in step S404, the procedure goes to the next signature, whereupon the procedure returns to step S402 described above. Otherwise, in step S405, the signature performing module 104 signs the document. In step S406, the determining module 105 determines whether the current designated signer is the last one. If the current designated signer is not the final signer, in step S407, the transmitting module 101 transmits an evaluated decision to the next signer according to the analysis result, whereupon the procedure returns to step S307 described above. Otherwise, the procedure goes to step S309 described above.

Although the present invention has been specifically described on the basis of a preferred embodiment including a preferred method, the invention is not to be construed as being limited thereto. Various changes or modifications may be made to the embodiments including the methods without departing from the scope and spirit of the invention.

What is claimed is:

1. An electronic signature system, the electronic signature system comprising a server and a database, wherein:
the database stores a plurality of signature selections;
the server comprises:
a signature task setting module for receiving a request for signing a document which has a document type, and setting the signature procedure according to the document type;
a transmitting module for simultaneously distributing the document to designated signers;
a signature selection setting module for receiving a signature selection selected by each signer in real-time;
a signature selection analyzing module for obtaining the signature selections, analyzing the signature selections, thereby generating an analysis result;
a determining module for determining whether a current designated signer has a right to sign the document according to the analysis result; and
a signature performing module for signing the document if the current designated signer has a right to sign the document;
wherein the transmitting module transmits an evaluated decision to a next designated signer according to the analysis result.

2. The electronic signature system according to claim 1, wherein the determining module further determines a signature order option according to the document type.

3. The electronic signature system according to claim 2, wherein the signature order option comprises non-ordered option and hierarchal ordered option, the hierarchal ordered option corresponding to the signature selections.

4. The electronic signature system according to claim 3, wherein the signature selections comprise: signer delegation selection, pass on selection, direct comment selection, pass on selection, direct signature selection, signer supplement selection, and signer cancellation selection.

5. The electronic signature system according to claim 1, wherein the analysis result comprises document signed and document not signed.

6. The electronic signature system according to claim 1, where the determining module further determines whether the current designated signer is the last designated signer, and the transmitting module distributes the signed document to designated recipients whom are either the designated document signers or document informers or both if the current signer is the last one.

7. A electronic signature method used in an electronic signature system, comprising the steps of:
receiving a request for signing a document which has a document type;
setting a signature procedure according to the document type;
simultaneously distributing the document to designated signers;
receiving a signature selection selected by each designated signer;
obtaining the signature selections, and analyzing the signature selections, thereby generating an analysis result;
determining whether a current designated signer has a right to sign the document according to the analysis result;
signing the document if the current designated signer has a right to sign the document, and
transmitting an evaluated decision to the next designated signer according to the analysis result.

8. The electronic signature method according to claim 7, further comprising the step of determining a signature order option according to the document type.

9. The electronic signature method according to claim 7, wherein the signature order option comprises non-ordered option and hierarchal ordered option, the hierarchal ordered option corresponding to the signature selections.

10. The electronic signature method according to claim 9, wherein the signature selections comprise: signer delegation selection, pass on selection, direct comment selection, direct signature selection, signer supplement selection, and signer cancellation selection.

11. The electronic signature method according to claim 7, wherein the analysis result comprises document signed and document not signed.

12. The electronic signature method according to claim 7, further comprising the steps of:
determining whether the current designated signer is the last one; and
transmitting the signed document to designated recipients whom are either the designated document signers or document informers or both if the current designated signer is the last one.

13. A computer enabling electronic signature, the computer comprising:
a signature task setting module for receiving a request for signing a document which has a document type, and setting the signature procedure according to the document type;
a transmitting module for simultaneously distributing the document to designated signers;
a signature selection setting module for receiving a signature selection selected by each signer in real-time;
a signature selection analyzing module for obtaining the signature selections, analyzing the signature selections, thereby generating an analysis result;
a determining module for determining whether a current designated signer has a right to sign the document according to the analysis result; and
a signature performing module for signing the document if the current designated signer has a right to sign the document;
wherein the transmitting module transmits an evaluated decision to a next designated signer according to the analysis result.

14. The computer according to claim 13, wherein the determining module further determining a signature order option according to the document type.

15. The computer according to claim 14, wherein the signature order option comprises non-ordered option and hierarchal ordered option, the hierarchal ordered option corresponding to the signature selections.

16. The computer according to claim 15, wherein the signature selections comprise:
signer delegation selection, pass on selection, direct comment selection, direct signature selection, signer supplement selection, and signer cancellation selection.

17. The computer according to claim 13, wherein the analysis result comprises document signed and document not signed.

18. The computer according to claim 13, where the determining module further determines whether the current designated signer is the last one, and the transmitting module distributes the signed document to designated recipients whom are either the designated document signers or document informers or both if the current designated signer is the last one.
